(19) United States
(12) Patent Application Publication
(10) Pub. No.: US 2010/0131374 A1
(43) Pub. Date: May 27, 2010

(54) Integrated Currency Scales

(75) Inventors: William Thomas Sanders, Denver, NC (US); Daniel Christopher Bohen, Charlotte, NC (US); Shane Anthony Johnson, Charlotte, NC (US); Amy Baker Folk, Charlotte, NC (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 12/277,867

(22) Filed: Nov. 25, 2008

(51) Int. Cl. G07F 7/04; G06Q 20/00

(52) U.S. Cl. 705/16; 194/206

(57) ABSTRACT

To facilitate the monitoring of currency and coin levels in a point of sale system and other cash handling devices, one or more currency or coin scales may be integrated into the point of sale system or cash handling device. Currency and coin amount information may be transmitted to a back office system or to a financial institution for recognition of the funds. A measurement by the scale may be triggered by a transaction occurring, based on a specified schedule or in an on-demand fashion.

### BACKGROUND

Businesses and other organizations often require a supply of cash to fund transactions such as providing change for customer purchases. In some instances, such businesses and organizations use a cash handling device to provide an accessible cash supply. Occasionally, the supply of cash (e.g., specific denominations of currency) must be replenished. Typically, to replenish the supply of cash, a business will have to monitor a cash handling device and manually submit a request for more cash (i.e., a change order) to a financial institution.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to aspects of the present disclosure, a cash handling device such as a cash register may include integrated currency and/or coin scales. Currency and coin scales are configured to determine an amount of currency or coin based on their weight. Using such an integrated system, data regarding the financials of the cash handling device may be immediately determined and retrieved as needed. Additionally, funds do not need to transferred to a currency or coin counting machine just to obtain a determination of an amount of funds.

According to another aspect, a point of sale system having a coin scale might not include a paper currency scale. In such instances, reconciliation may be facilitated by receiving coin amount information from the point of sale system while determining paper currency amount information at the reconciliation device. For example, an employee such as a cashier may transport the paper currency to the reconciliation device (e.g., a currency recycler), at which point the reconciliation device may determine an amount of paper currency deposited into the device.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 illustrates a simplified diagram of a cash recycler that may be used in accordance with the operating environment of FIG. 1.

FIG. 3 illustrates various features of cash recyclers used in various aspects described herein.

FIG. 4 illustrates a system configuration that may be used in accordance with an aspect described herein.

FIG. 5 illustrates a point of sale system having an integrated currency scale according to one or more aspects described herein.

FIG. 6 illustrates an example method for determining an amount of currency or coin in a point of sale system according to one or more aspects described herein.

FIG. 7 illustrates an example method for retrieving currency and coin information according to one or more aspects described herein.

FIG. 8 illustrates an example method for reconciliation funds from a point of sale system according to one or more aspects described herein.

### DETAILED DESCRIPTION

Aspects of the present disclosure relate to cash handling devices. Cash handling devices generally refer to devices that are configured to accept and/or dispense currency. Cash handling devices include payment kiosks, point of sale systems such as cash registers, automated teller machines (ATMs), depository machines, currency recyclers and the like. Currency recyclers generally refer to cash handling devices that are configured to dispense the same currency that was earlier deposited. For example, if a user deposits a five-dollar bill into a cash recycler machine, the same five-dollar bill may be dispensed during a subsequent withdrawal transaction. Thus, using currency recyclers, deposited currency may be placed immediately back into use and circulation instead of being held or frozen until a bank is able to collect and reconcile the funds, stored indefinitely and/or taken out of circulation entirely as is the case with other current cash handling devices.

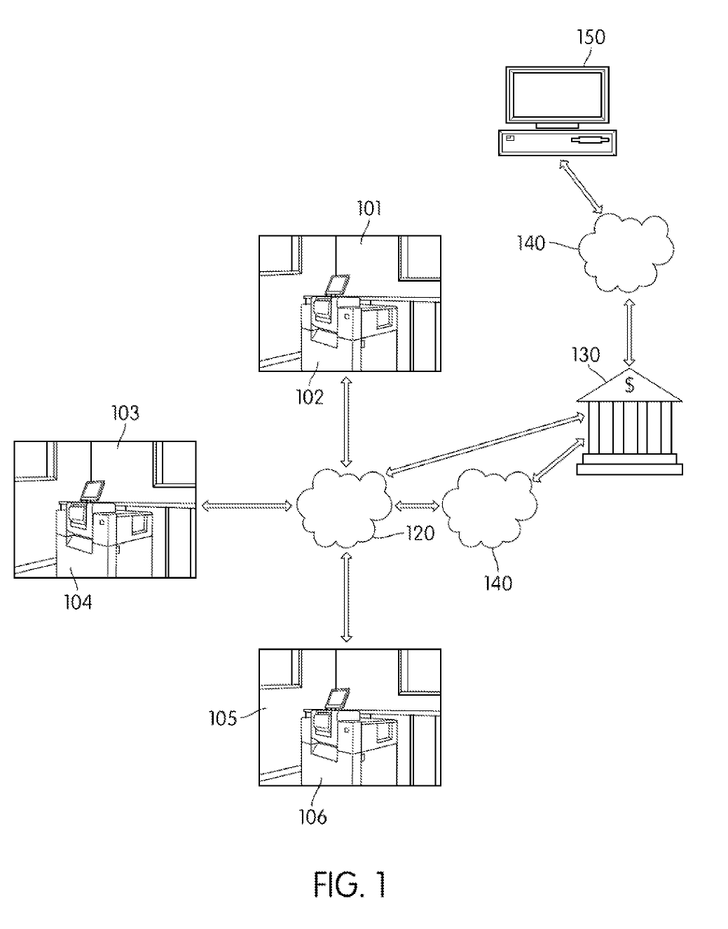

FIG. 1 illustrates an example of a suitable operating environment in which various aspects of the disclosure may be implemented. Devices 102, 104, 106 may include currency recyclers and/or other cash handling devices and may be located at various sites such as locations 101, 103, and 105. The locations may represent different stores of a business enterprise. For example, locations 101, 103, and 105 may represent three different grocery stores located in different geographical areas belonging to a grocery store chain. Those skilled in the art will realize that additional cash handling devices may be located in the same store or in other stores belonging to the grocery store chain. In addition, those skilled in the art will realize that a grocery store chain is only one illustrative example of the types of locations or businesses that cash handling devices such as recyclers may be located. For example, cash recyclers may also be located in gas stations, post offices, department stores, and other places where cash and other financial instruments are deposited or withdrawn.

FIG. 1 further illustrates that cash handling devices 102, 104, and 106 may be connected to a communications network such as communications network 120. Communications network 120 may represent: 1) a local area network (LAN); 2) a simple point-to-point network (such as direct modem-to-modem connection); and/or 3) a wide area network (WAN), including the Internet and other commercial based network services.

Cash handling devices 102, 104, and 106 may communicate with one another or with a financial institution such as bank 130 via communication network 120 in various manners. For example, communications between cash handling devices 102, 104, 106 and bank 130 may use protocols and networks such as TCP/IP, Ethernet, FTP, HTTP, BLUETOOTH, Wi-Fi, ultra wide band (UWB), low power radio frequency (LPRF), radio frequency identification (RFID), infrared communication, IrDA, third-generation (3G) cellular data communications, Global System for Mobile communications (GSM), or other wireless communication networks or the like. Communications network 120 may be directly connected to a financial institution such as bank 130. In another embodiment, communications network 120 may be connected to a second network or series of networks 140 such as the STAR network before being connected to bank 130. According to one or more arrangements, bank 130 may utilize an infrastructure which includes a server 150 having components such as a memory, a processor, a display, and a communication interface.

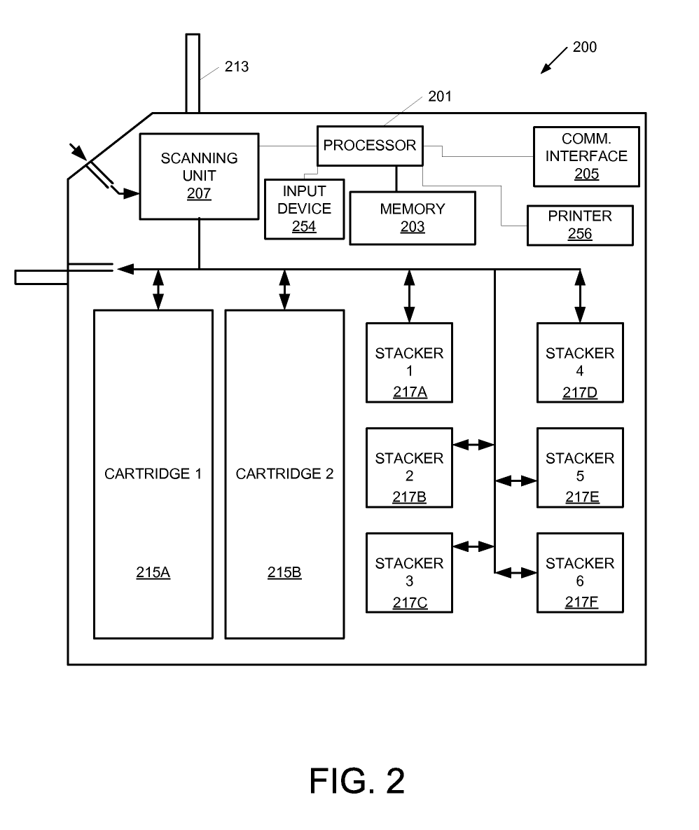

FIG. 2 illustrates a simplified diagram of a cash recycler that may be used in accordance with the operating environment of FIG. 1. Cash recycler 200 may include processor 201, memory 203, communication interface 205, scanning unit 207, display 213 and various cartridges 215 and recycling units such as stackers 217 or rolled stored modules (RSMs). Processor 201 may be generally configured to execute computer-readable instructions stored in memory 203 such that, for example, cash recycler 200 may send and receive information to and from a bank (e.g., bank 130 of FIG. 1) using communication interface 205 and via a network (e.g., networks 120 and/or 140 of FIG. 1). Memory 203 may be configured to store a variety of information including the aforementioned computer-readable instructions, funds balance data, reconciliation data, user account information and the like. Additionally, memory 203 may include non-volatile and/or volatile memory. One or more databases may be stored in the memories 108, 112, and 116.

Cash recycler 200 may further provide display 213 to present data and/or messages to a user. For example, display 213 may be configured to display a recycler balance, a transaction interface, a current deposit count, security options, transportation options and the like. One or more input devices 254 such as a keypad, keyboard, mouse, touchscreen, fingerprint scanner, retinal scanner, proximity card reader, RFID scanner and/or writer, magnetic card reader, barcode reader, and/or combinations thereof, or any other type of input device or reader capable of inputting, reading, or scanning indicia or information, may also be included in or connected to recycler 200. One or more printers 256 may also be included in or connected to recycler 200 for printing receipts and notifications as well.

In cash recycler 200, stackers 217 and cartridges 215 are configured to store currency. Currency may be inserted through input slot 209 and withdrawn through withdrawal slot 211. Stackers 217 may be used to store and organize currency based on denomination. For example, all $5 bills may be stored in stacker 2 (i.e., stacker 217B) while all $20 bills may be stored in stacker 3 (i.e., stacker 217C). Cartridges 215A and 215B, on the other hand, may be used to store overflow currency and/or currency for transport. Thus, if stackers 217 become full, additional currency that is deposited into recycler 200 may be stored in an overflow cartridge such as cartridge 215B. One of cartridges 215 may be designated as a transport cartridge that stores currency to be withdrawn from the machine and transported to the bank. Alternatively or additionally, one or more of cartridges 215 may be used as an unfit bill store for currency determined to be defective to a degree that it should be taken out of circulation. Cartridges 215 and stackers 217 may further be removable for easier access or transport. In some configurations, RSMs (not shown) may be used instead of or in addition to stackers 217.

Scanning unit 207 may be configured to scan each bill or currency that is inserted into recycler 200. Scanning unit 207 may be configured to detect defects, counterfeits, denomination, type of currency (e.g., which country the currency originates from) and the like. Scanning unit 207 may further be configured to refuse money (either through input slot 209 or withdrawal slot 211) if it cannot be properly recognized or if the currency is deemed to be counterfeit. Scanning unit 207 may send such data to processor 201 which may, in turn, save the data in memory 203.

Further, recycler 200 may include one or more mechanical or electromechanical systems (not shown) for automatically transferring currency between stackers 217, cartridges 215, input slot 209 and withdrawal slot 211 in recycler 200. For example, currency may automatically be withdrawn from stackers 217 and directed into cartridge 215A for storage using a series of motorized rollers. In another example, currency stored in cartridge 215A may be withdrawn and organized and stored into stackers 217 according to denomination. Using such systems to facilitate the automated movement of currency between storage components and other portions of recycler 200 may provide efficiency and security by alleviating some of the need to manually handle currency stored within recycler 200.

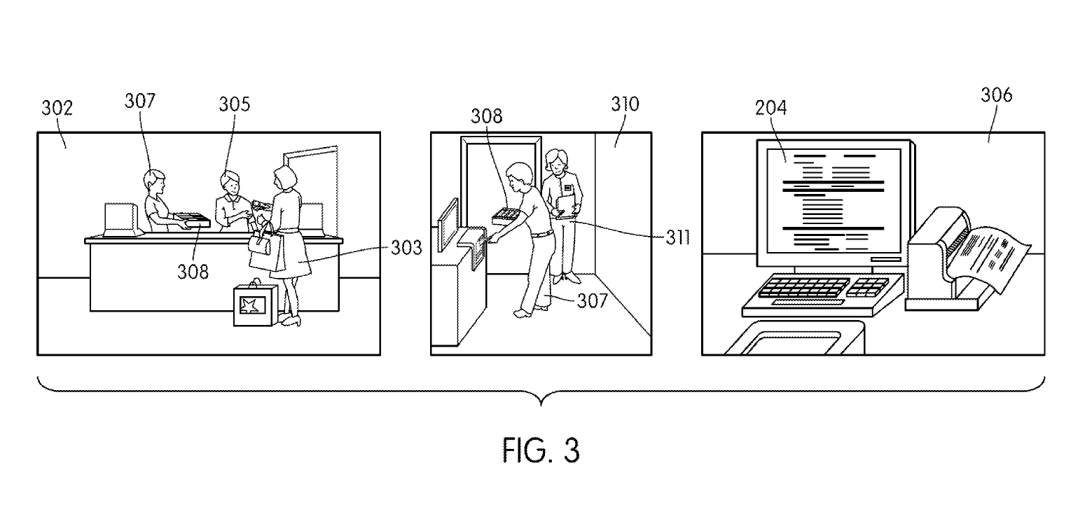

FIG. 3 illustrates various features of cash recycler, such as cash recycler 200 of FIG. 2, used in various aspects of the invention. The images in FIG. 3 depict use of a single cash recycler 200 in a retail environment. The retail owner may have a cash recycler 200 located in each of their stores. In an aspect of the invention, summary information for the retail owner's stores may be available via an interface to the financial institution. In another embodiment, access to summary information may be available directly from each of the cash recyclers 200.

In FIG. 3, image 302 depicts customer 303 paying cash to a retail employee such as store cashier 305 for a purchase. Another store cashier 307 at a recently closed cash register may be carrying a cash drawer or till 308 to a back office for reconciliation. In image 310, store cashier 307 may load currency from cash register till 308 into cash recycler 200. In addition, store cashier 307 may also deposit other paper forms of payment received from customer such as checks. An office manager 311 may be supervising cashier 307 during the loading of cash register till 308 into cash recycler 200. Moreover, upon the start of a shift a cashier may fill his/her cash register till with a designated amount of currency dispensed from cash recycler 200.

In image 306 of FIG. 3, a display screen (e.g., display 213 of cash recycler 200 of FIG. 2) may show the total amount entered into cash recycler 200 from till 308. The display screen 213 may provide a break down of the amount entered into cash recycler 200 by denomination and by each cashier. The total amount deposited and withdrawn from cash recycler 200 may be shown on display screen 213.

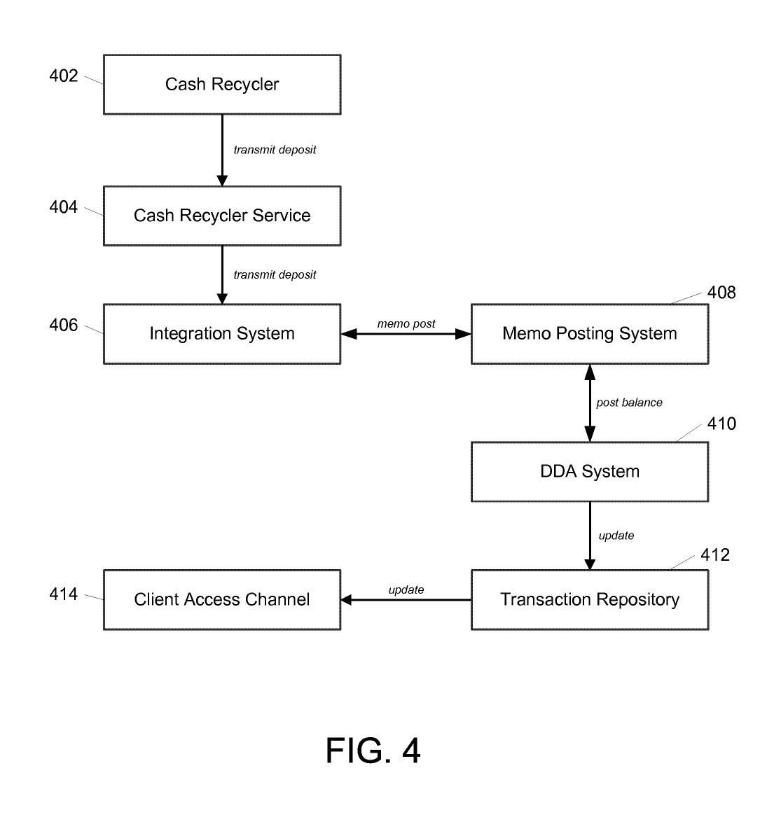

FIG. 4 illustrates a system configuration that may be used in accordance with an aspect of the invention. In FIG. 4 a cash recycler 402 may communicate information to cash recycler service 404 located at a remote location. For example, cash recycler 402 may communicate deposit and withdrawal information from an enterprise location (e.g., a retail store) to the remote cash recycler service 404. The information may be routed through various networks such as the Internet to reach the cash recycler service. The cash recycler service 404 may be located in the data center of a financial institution. The cash recycler service 404 may communicate with an integration system 406 which provides access to the financial systems and processes. The integration system 406 may communicate with a memo posting system 408 which may perform posting activity. The posting system 408 may update the appropriate DDA (direct deposit account) system 410 to reflect the balance changes in the enterprises account balances. The DDA system 410 may also update a transaction repository 412 for historical and intra-day reporting purposes. An enterprise employee may access information stored in the transaction repository 412 through a client access channel 414 via web browser. Those skilled in the art will realize that the financial institution may allow the enterprise user to access the information stored in the transaction repository via numerous alternative communication methods.

According to one aspect, cash recyclers such as cash recycler 102 (FIG. 1) and 200 (FIG. 2) and other cash handling devices may facilitate real-time recognition of funds. In particular, funds deposited at a recycler or other cash handling device at a client site may be recognized by a bank at the time the deposit is made. Recognition refers to the real credit (i.e., not provisional) of deposited funds into a client's account. In contrast to current systems, there is no delay between a deposit of funds and when the funds and transaction data are submitted to the bank for recognition. Thus, instead of having to wait until the end of the day or another prescheduled time for deposits and/or withdrawals to be recognized by the bank, each deposit is processed for recognition in real-time. Data regarding the withdrawal or deposit transaction may be transmitted through a data network to the bank for recognition and processing. Providing real-time recognition offers many advantages including the ability for a client to withdraw the same currency that was earlier deposited for use in the client's operations, all at the client site and without having to first transport the deposited funds to the bank for recognition. Currency recyclers, recycling management and recognition of funds are further described in U.S. application Ser. No. 11/614,656, entitled “Commercial Currency Handling and Servicing Management,” filed on Dec. 21, 2006, and U.S. application Ser. No. 12/241,385, having attorney docket no. 007131.00267, entitled “Immediate Recognition of Financial Transactions,” and filed on Sep. 30, 2008, the content of each being incorporated herein by reference in its entirety.

As described, using a back office currency recycler may require a user to physically transport paper currency and/or coin from a point of sale system such as a cash register to the recycler for reconciliation at the end of the day. Similarly, when a cash register is opened or an employee is beginning his or her shift, cash may be withdrawn from the recycler and transported to a particular register. Thus, a cash recycler and a financial institution might not have information about the amount of currency or coin within a register until the end of the day or shift when an employee brings a till to the recycler for reconciliation and deposit. Similar issues may also arise for other types of cash handling devices.

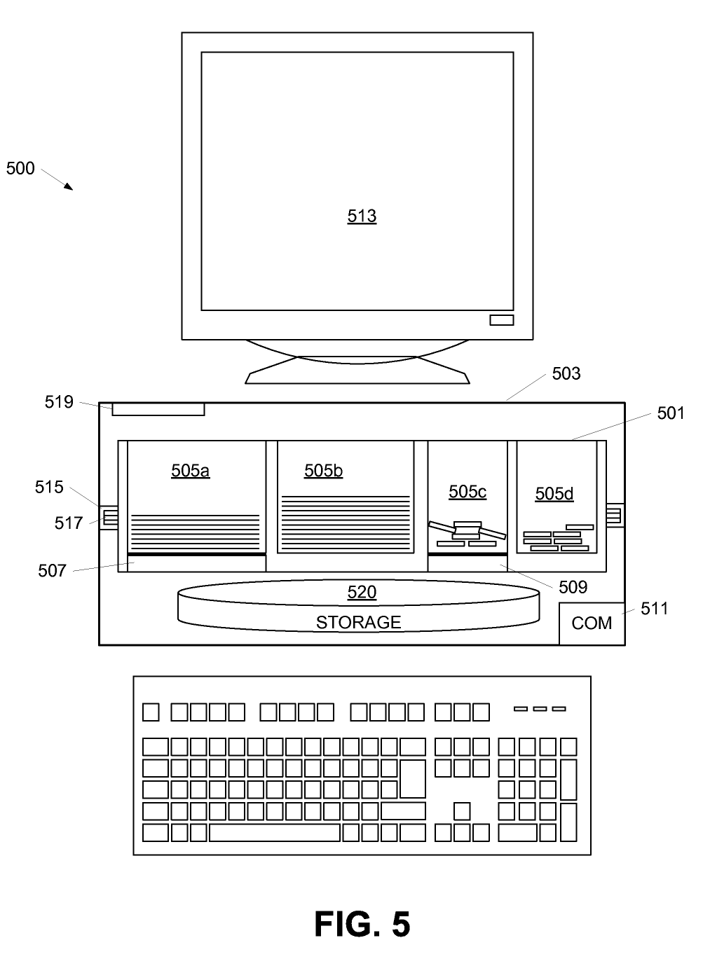

FIG. 5 illustrates a point of sale system 500 that includes cash drawer 501 configured to slide in and out of housing 503. Cash drawer 501 may be configured to store both currency and coin. In addition, cash drawer 501 may include multiple compartments 505 for storing different denominations of currency and coins, a currency scale 507 and a coin scale 509 that may each be used to determine an amount of currency and coin, respectively, currently stored in the point of sale system 500. Point of sale system 500 further includes a communication interface 511 for transmitting transaction and other financial data to other devices including a back office cash recycler or server, a financial institution server and the like. Display 513 is configured to display transaction and system information as needed. Display 513 may be a touch-sensitive display to further facilitate information entry. In one or more arrangements, point of sale system 500 may further include card readers (e.g., credit card or employee ID card readers), receipt printers, automated change dispensers, programmable input devices (e.g., keyboards with keys for different products) and the like. Examples of current currency scales include CASHMASTER and KLOPP COIN.

Cash drawer 501 may slide in and out of housing 503 along slide brackets 515 using rollers 517. In one or more arrangements, housing 503 may include a sensor 519 that is configured to detect when cash drawer 501 is fully inserted into housing 503. Full insertion may also trigger a locking mechanism (not shown) that prevents withdrawal of drawer 501 until the lock is released (e.g., by entering an authorization code or conducting a corresponding transaction). Cash drawer 501 may further be removable from housing 503 and point of sale system 500 so that an employee may bring cash drawer 501 to another device (e.g., a cash recycler) for reconciling and/or depositing funds.

Currency scale 507, as illustrated, is positioned at the bottom of drawer 501 and underneath compartment 505a such that scale 507 may sense the weight of compartment 505a and its contents. One or both of compartments 505 and/or currency scale 507 may be removable from drawer 501. Currency scale 507 may include a data connection to a controller or processor in point of sale system 500. Alternatively or additionally, currency scale 507 may provide currency and coin data to a remote system (e.g., a back office management system or cash handling device) through a network connection. Although a single currency scale 507 is illustrated, multiple currency scales may be used, e.g., one for each of compartments 505.

In one or more configurations, point of sale system 500 may further include a storage device 520 such as a computer readable media device for storing a database of information. Storage device 520 may be configured to store transaction data, an amount of funds log, employee login/logout logs and the like. The data may be stored indefinitely in storage device 520 or until the data is transferred to another system such as a back office server.

According to one or more aspects, a point of sale system might not include currency scales for paper currency portions. Paper currency might instead be transferred between a point of sale system and a cash room or back office safe for security purposes. Thus, the currency may be counted when transferred rather than while stored in the point of sale system. Coin, on the other hand, might not pose as great of a risk and thus, remain in a point of sale system. Accordingly, coin scales may be used for the coin portions of the system to detect the amount stored therein. Thus, reconciliation may be performed using the data from the counting or determination performed when the paper currency is transferred to the back office in addition to the coin information that may be determined using the coin scales in the point of sale system. In yet another configuration, a point of sale system may include paper currency scales but not coin scales.

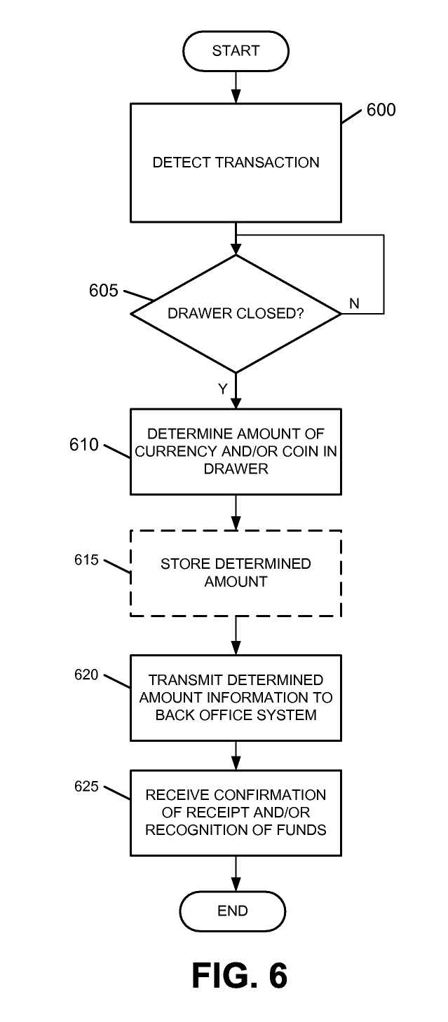

FIG. 6 illustrates an example method for determining an amount of currency or coin in a point of sale system. In step 600, a point of sale system may detect that a transaction is being made or has been made. The detection may involve identifying that user input corresponds to a transaction, opening or closing of a register drawer, changes in weight of the compartments in the register drawer and/or combinations thereof. If a transaction is being made or has been completed, the point of sale system may determine whether the register drawer or some other money storage facility is closed or in a predefined position in step 605. Step 605 may be required in order to insure that an amount of currency and coin in the drawer or compartments thereof are undisturbed during a currency and coin amount determination/verification process. For example, the point of sale system may determine whether the register drawer is in the predefined or secured position based on sensors (such as sensor 519 in FIG. 5) or based on whether a lock has been triggered. If the register drawer is in the predefined position, the point of sale system may determine an amount of currency and coin in the drawer in step 610. The determination process may include a period where the weight is allowed to stabilize within the drawer. The period may be defined by a specific amount of time, a degree of weight fluctuation, time between fluctuations and the like.

Optionally, in step 615, the amount of currency or a change in the amount of currency or coin may be stored. The amount may further be stored in association with a transaction identifier to log the amount involved in the transaction. In step 620, the amount of currency or coin and/or the transaction information may be transmitted through a network to a back office system. Alternatively or additionally, the transaction information may be transmitted to a financial institution for immediate recognition of funds (e.g., where money was added to the point of sale system). In step 625, the point of sale system may receive a confirmation that the information was received and/or the amount of funds was recognized.

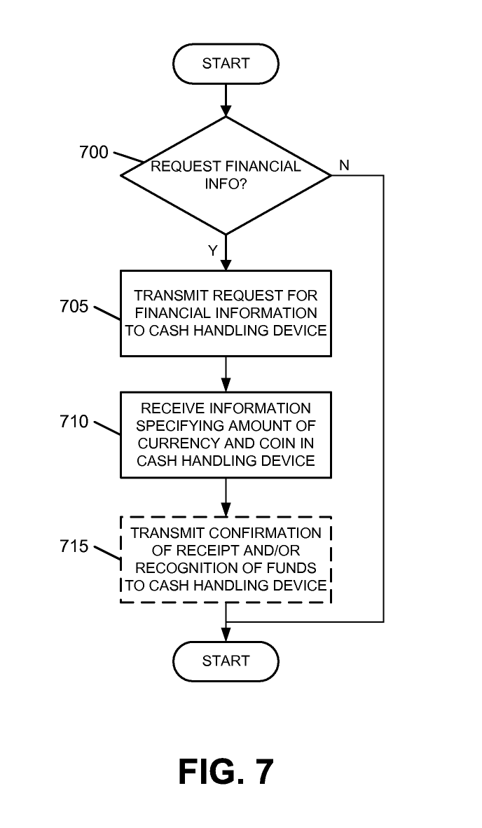

With a currency scale integrated into a point of sale system or other currency handling device, a back office system or a financial institution may also request an accounting of funds in those devices on a periodic or aperiodic basis. FIG. 7, for example, illustrates a method for retrieving currency and coin amount information from a point of sale system or other cash handling device. In step 700, a system may determine whether to request financial information from a specified cash handling device. The determination may be based on a predefined schedule, an on-demand request, beginning or end of employee shifts, closing or opening times of business and/or combinations thereof. If the system determines that it is to request a currency and coin accounting from the cash handling device, the system may issue such a request to the cash handling device in step 705. In response to the request, the system may receive information regarding an amount of currency and coin in the cash handling device in step 71 0. Optionally, the system may transmit a confirmation of receipt and/or recognition to the cash handling device in step 715.

The features and aspects described herein may be used in various types of cash handling devices beyond point of sale systems. For example, features like integration of a currency or coin scale may be included in automated teller machines, coin exchange systems and the like so that an amount of currency or coin in the device may be determined without having to remove the funds from the machine. Reconciliation and recognition may be processed more quickly and efficiently using integrated currency and coin scales. In addition to or as an alternative to currency scales, other currency or coin amount determination mechanisms may be used. For example, an amount of currency or coin in a device may be determined based on the height of a stack of coins or bills.

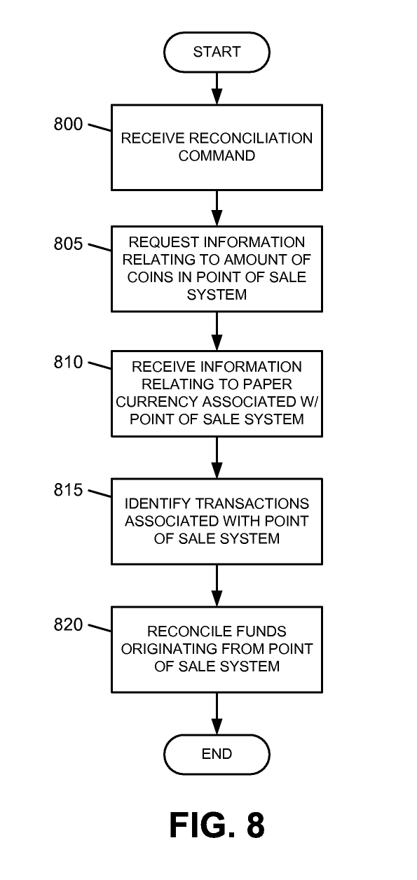

FIG. 8 illustrates a method for reconciling funds from a point of sale system. In step 800, a cash handling device or a financial institution server may receive a reconciliation command. The command may originate from manual input or an automated scheduling process. In step 805, the system may request information relating to an amount of coins in a point of sale system from the point of sale system. The point of sale system may include one or more coin scales that are able to determine (based on weight, for example) the amount of coin funds in the point of sale system. In step 810, the system may subsequently receive information relating to an amount of currency associated with the same point of sale system. The information may be received from the point of sale system, a separate currency counting device or from an internal counting mechanism of the financial institution server or cash handling device. In one example, the paper currency information may be received from an internal counting mechanism of the cash handling device upon an employee or user transferring the paper currency from the point of sale system to the cash handling device (e.g., at the end of a shift or day). In step 815, the system may further identify transactions associated with the point of sale system being reconciled. Transaction information may be sent from the point of sale system to the back office or the financial institution as the transaction occurs or at specified times. Alternatively or additionally, the point of sale system may store transaction information throughout the day or shift and provide such information in an on-demand manner. In step 820, the funds originating from the point of sale system may be reconciled based on the transaction information.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

We claim:

1. A point of sale apparatus comprising:
a drawer having:
a first compartment configured to store currency; and
a second compartment configured to store coin,
wherein at least one of the first and second compartments includes a scale configured to determine an amount of currency or coin in the at least one of the first and second compartments.

2. The point of sale apparatus of claim 1, further comprising a communication component configured to transmit information regarding the amount of currency or coin to a remote system.

3. The point of sale apparatus of claim 2, wherein the remote system is a cash recycler.

4. The point of sale apparatus of claim 2, wherein the remote system is an account reconciliation server at a financial institution.

5. The point of sale apparatus of claim 1, further comprising a housing configured to receive the drawer.

6. The point of sale apparatus of claim 5, wherein the scale is configured to determine the amount of currency only when the drawer is fully inserted in the housing.

7. The point of sale apparatus of claim 6, further including a sensor configured to indicate full insertion of the drawer into the housing.

8. A device for storing money comprising:
a compartment configured to store at least one of: currency and coin; and
a scale configured to determine an amount of the at least one of currency and coin based on the weight of the at least one of currency and coin,
wherein the device is configured to be inserted into a point of sale system.

9. The device of claim 8, wherein the scale is removably attached to the compartment.

10. The device of claim 8, further comprising a plurality of compartments, each compartment configured to store a denomination different from the other compartments.

11. The device of claim 10, further comprising a plurality of scales, each scale associated with a compartment different from the other scales.

12. A method of monitoring currency information in a system, comprising:
detecting a transaction at a point of sale system;
determining that the transaction is complete;
determining an amount of at least one of currency and coin within the point of sale system, wherein determining the amount includes weighing the at least one of currency and coin using a scale integrated into the point of sale system;
storing the determined amount of the at least one of currency and coin; and
transmitting the determined amount of the at least one of currency and coin to a central server.

13. The method of claim 12, wherein the step of determining the transaction is complete includes receiving an indication from a sensor that a drawer of the point of sale system is closed.

14. The method of claim 12, wherein the step of determining an amount includes determining an amount of both currency and coin using the scale.

15. The method of claim 12, wherein the step of determining an amount includes determining an amount of both currency and coin using separate scales for the currency and coin.
